(19) United States
(12) Patent Application Publication
(10) Pub. No.: US 2008/0154960 A1
(43) Pub. Date: Jun. 26, 2008

(54) Progress and performance management method and system

(76) Inventor: Steven Francisco, Bronx, NY (US)

Correspondence Address: Klaus P. Stoffel;Wolff & Samson PC, One Boland Drive, West Orange, NJ, 07052, US

(21) Appl. No.: 11/644,550

(22) Filed: Dec. 21, 2006

(51) Int. Cl. G06F 17/30

(52) U.S. Cl. 707/104.1; 707/E17.005

(57) ABSTRACT

A method and system for collecting and tracking objective and subjective performance data of students by selecting data entry fields to be tracked, assigning a bar code to each data entry field, scanning the bar code of a desired data entry field, entering objective data, for example as audio, image and/or video input, relative to the desired data entry field into a central database, and accessing the entered data at a later date for subjective evaluation relative to student performance.

### BACKGROUND OF THE INVENTION

The present invention relates to a method and system for collecting objective and subjective data to track performance, in particular of students.

A number of performance tracking systems and instruction systems are known in the art.

U.S. Patent Application Publication Number 2005/0069853 to Tyson, et al. describes performance tracking systems and methods. One embodiment describes receiving standardized physical performance test data over a network from a test site, which standardized physical performance test data corresponds to physical performance for a plurality of individuals, and processing the standardized physical performance test data to provide standardized data of physical performance among the plurality of individuals.

U.S. Patent Application Publication Number 2003/0232319 to Grisham, et al. discloses a network-based method and system for sensory/perceptual skills assessment and training. The system includes an assessment module or system, training modules, a centralized database for storing assessment, training and other data, and a feedback mechanism for parents, teachers and doctors that allows immediate input regarding either a particular person's data or a group analysis.

U.S. Pat. No. 6,606,479 to Cook, et al. discloses an agent based instruction system and method. Disclosed are one or more service systems with sufficiently large data capacity discs for storing all school-student data, all instructional materials, and all software used in the system. Optionally, the service can use more student data objects in an object-oriented database. The method is used to distribute software, instructional materials, and school-student data from these servers. In alternative embodiments there can be more than one server with software and data component storage divided as convenient across the servers. In further embodiments, the server can be a central host system. Access to the school-student data allows teachers and administrators to track student performance by class, grade, subject, school, etc.

U.S. Patent Application Publication No. 2003/0134261 to Jennen, et al. discloses a system and method for assessing student achievement levels for purposes of identifying students at risk for not meeting minimum academic standards as measured using standardized tests, and for tracking or monitoring student academic performance levels. The system and method comprise producing a pool of curriculum-independent general outcome measures (GOMs) of substantially equal difficulty for a particular grade level, and further comprises a system and method of assessing and monitoring students in that grade level using the pool of GOMs for the purpose of identifying those students at risk for not meeting minimum standardized test target scores and for tracking or monitoring student academic performance levels. The system comprises a database accessible remotely by authorized users through a network and user interface in which authorized users can remotely input student academic performance information and selectively retrieve that information for display through the user interface.

U.S. Patent Application Publication No. 2006/0172274 to Nolasco discloses a system and method for real time tracking of student performance based on state educational standards. This tracking system platform provides the ability to access all of the stored data and control modules of the tracking system. This includes state educational standards, lesson plans, the assignments, the student grade data, student demographic data and behavior and attendance data. In addition to providing the ability to access and manipulate all of this data, the tracking system platform provides web based graphical user interfaces and provides the ability to externally access the state educational standards website via the internet. The tracking system platform controls all aspects of module registration application structure, security and permissions.

U.S. Patent Application Publication No. 2005/0053908 to Satheesh, et al. discloses an education management system, method and computer program. The system enables monitoring of students' progress, provides automated or manually generated feedback, compares scores of different students in a class or across classes, assess the quality of questions and compares performance of various classes, using the control software and the data stored in the main database.

U.S. Patent Application Publication No. 2004/0215587 to Bertrand, et al. discloses a goal based educational system with support for dynamic characteristic tuning. According to this system, while a student is performing the work in various tasks, every action taken, the feedback the student receives and any other indicators are tracked in the student tracking database. Periodically, all or part of the tracked data are transmitted to a central location. The data can be used to verify the student completed all of the work and can be further analyzed to measure his degree of mastery of the content.

U.S. Pat. No. 6,704,541 to Ciarallo, et al. discloses a method and system for tracking the progress of students in a class. The system includes a computer network having a school computing system and one or more student computers connected with the school computing system by a communication link. The school computing system includes one or more databases adapted to store data relating to the performance of course activities by one or more students in the course. The school computing system also includes a course graphic generator adapted to generate one or more course graphics representative of the course and a progress graphic generator that can generate one or more progress graphics representative of the progress of the one or students in the course.

U.S. Patent Application Publication Number 2004/0110119 to Riconda, et al. discloses a web-based knowledge management system and method for education systems. Riconda discloses what they call the eSD System which they disclose to be a robust data schema and database engine that stores and tracks virtually every data element about a student, captured and stored in a student record, according to a data content template customized at the school district level, and generates an output that is presented in a logical, meaningful manner. This system enables member users to add data for inclusion in the student portfolio database.

U.S. Patent Application Publication Number 2004/0033475 to Mizuma, et al. discloses a method and system for monitoring and managing the educational progress of students. The Mizuma system relates generally to educational systems and can include methods of using a computer system to create student records in a database, methods of using a computer system to present student records stored in a computer database, methods for measuring a student's performance relative to predetermined educational goals, automated processes that utilize a relational database for student education, automated educations systems, and computer programs for automating an education system.

Essentially there are four different types of “data” which are relevant for performance evaluation. First is subjective data which is information gathered by opinion, observation or judgment. Second is objective data which is information gathered by some means independent of the examiner or teacher, such as test results. Third is formative data which is data, analysis, or some evaluation which is useful in process. This type of data can be used to change what is being taught as it happens. Fourth is summative data which is data, analysis or evaluation that is obtained after completion of a process. This type of data may effect the next cycle, but generally cannot effect the current cycle of teaching as teaching has come to a close.

FIG. 1 is a graph showing the interplay of these data, together with some examples.

Although various methods and systems exist in the prior art, they all share a common draw back, namely they all deal with using only objective data and give no indications as to using subjective data which includes observations and opinions, or how such data can be entered and stored for further use.

### SUMMARY OF THE INVENTION

Accordingly, it is an object of the present invention to provide a method and system for entering and managing various subjective data such as observations and opinions, as well as objective data relative to numerous subjects, topics and students in a straight forward and uncomplicated manner.

Pursuant to this object, and others which will become apparent hereafter, one aspect of the present invention resides in a system for collecting objective and subjective data, which system includes a barcode scanner, software for generating barcodes, equipment for entering audio, image and/or video input, a central database for storing the audio, image and/or video input, and control software for accessing files based upon scanned barcodes and entering and updating information in the database. The system allows subjective data, such as teacher observations and opinions, to be entered in addition to conventional objective data such as test scores, attendance, etc.

Use of the system is straight forward. One manner in which the system is used will next be described. To begin with, the bar code of a specific student is scanned then, the desired topic or data entry field bar code is scanned and finally, data and/or information is/are entered into the database. The objective data can be input, for example, as numerical data as well as by audio, image or video means. The input can also occur by barcode scanning. This data and/or information is/are entered into the database immediately or at desired intervals (i.e. daily or weekly) so that the information can be called up as needed and desired by the teacher to permit the teacher to formulate opinions as to a student's performance. The subjective observations and/or opinions can then also be added to the database together with a date and time stamp of the entry. This unique system allows more than conventional data input such as test scores and attendance records. For example, if the bar code for the data entry field of reading is scanned it is possible to record the actual voice (objective data) of the student reading and then store this audio input for future comparison with the student's reading at a later date for performance evaluation by the teacher (i.e. subjective data). In this way, the teacher can determine if patterns exist, not only relative to reading, but also to other areas, and can use these patterns to better evaluate a student's progress. By providing bar codes which directly access specific data entry fields, it is not necessary to move through other fields or menus as is necessary with a number of prior art systems which utilize a computer screen and keyboard as the input mechanism. It is understood that the student file and data entry field can be accessed in a manner other than scanning.

Although at present bar codes are technologically easy to implement, the inventive system can just as easily utilize radio frequency identification (RFID) tags in place of bar codes. If an RFID tag is used, then the bar code scanner would be replaced with an appropriate reader for the RFID tag.

Most current applications of data in education are summative and, as such, lack the ability to correct problems and patterns as they arise. Similarly, through the use of summative testing these solutions create a level of stress in the students that can mire performance and lead to discipline and motivation problems. Furthermore, such testing gives teachers an incentive to “teach to the test” and not to deepen thought processes. As a result, higher order thinking, in aggregate, is suppressed and discouraged. To address this situation, the present invention takes a different approach to data collection. While not completely replacing objective data, the present invention relies upon multiple subjective measures. As these measures are the hallmark of effective teaching, teachers already participate in these processes daily in the form of conferences, anecdotals, and observations. However, these volumes of data are undervalued in traditional instructional management solutions. The present invention places the teacher's professional assessment at the forefront of their decision making. The inventive system and method also make the entry of and access to this subjective information extremely simple so that teachers can easily utilize the information and implement appropriate procedures in their classrooms.

Access to the database can be granted or limited as needed. The database is arranged in a mainframe within a secure network. Access to the database can take place over the internet from workstations and from home computers by those having appropriate authority to access the system. Since such networks and how to restrict access via the internet are known in the art applicant will not provide any further detailed description of how this can be carried out.

The present invention is an improvement over the prior art in that it places a much higher value on the teacher's opinion. The system organizes the teacher's opinions and observations, but does not think for the teacher by providing any evaluation of objective data. Further, the objective data stored in the system includes scans, voice recordings, video, etc. for reassessing, documenting and/or auditing teacher opinions. Additionally, the inventive system provides the ability to input and track data from all four quadrants shown in FIG. 1, which was not possible with any of the prior art systems. Finally, the present invention provides a straight forward method of entering observed, subjective information as well as for digital file importing and filing in the database.

One of the unique capabilities of the present invention is that it allows the educators to use data from their own opinions and correlations from their own data to drive decision making as to further education without the need for using large theoretical frameworks as the sole basis for decision making.

In addition to the use of the data by a teacher for decision making, it can be used in a variety of ways, including, but not limited to:

Audits:
Teacher training;
Principal check-ins (when a principal can check-in on student work without visiting each room); and
Quality audits (student and teacher audits).

Documentation:
Documentation for merit based pay systems;
Documentation for parent neglect (especially for health, neglect anecdotals); and
Documentation for referral to special education services.

Data persistence:
Persistence of needs data across several years (for example if a student is two years behind in reading it is now possible to set up a two year plan of things to teach the student to allow him/her to catch up);
Persistence of strengths data across several years (for example if a student displays gifted artistic ability it is possible to preserve a portfolio and teachers opinions of the ability so when the student goes to a higher grade, school, etc.).

Managing resources (additional teachers, efficient use of time):
Work order model for additional services (teacher A diagnoses student's reading problem which is relayed to teacher B who will provide additional support to the student;
Word order model for the class teacher; and
Grouping children into suggested small groups based on observed diagnostics (for example all children who need skill K).

Providing additional support:
Suggesting games or activities for home.

Of course there are numerous other possibilities for using the data and observations provided by the present system.

Other features and advantages of the present invention will become apparent from the following description of the invention that refers to the accompanying drawings.

### BRIEF DESCRIPTION OF THE DRAWINGS

FIG. 1 is a graph showing the interplay of objective-subjective-summative-formative data.

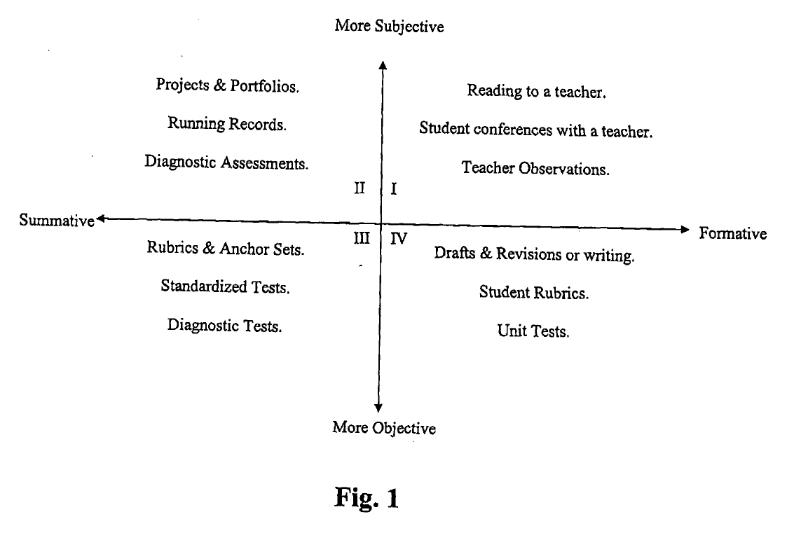

FIG. 2 shows a schematic overview of the centralized network for web based service of the inventive system and method.

FIG. 3 is a flowchart showing the operation of the system for tracking.

FIG. 4 is a flowchart showing how data is filed.

FIG. 5 is a flowchart showing importation of multimedia files.

### DETAILED DESCRIPTION OF THE INVENTION

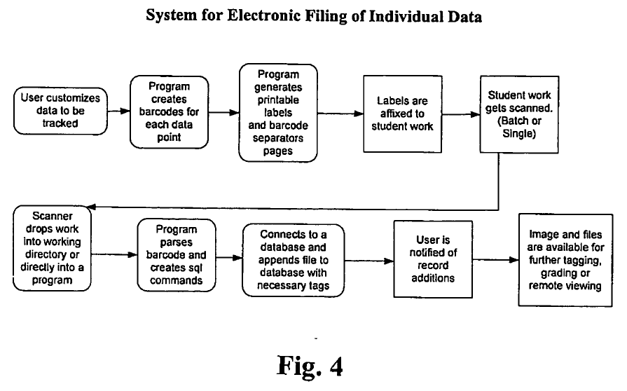

FIG. 4 is a block diagram showing one embodiment of how the data can be electronically filed. First, the user customizes the data to be tracked and then the program generates barcodes for each data point or field. The program further generates printable labels and barcode separators. The labels are affixed to the student work, at which point the student work is scanned, or entered as an audio, image or video input. The work is dropped into a working directory or directly into a program which parses the barcode and creates structured query language (SQL) commands. The file is then appended to the database with appropriate tags and the user is notified of the additions to the record. Finally, the input information is available for further use.

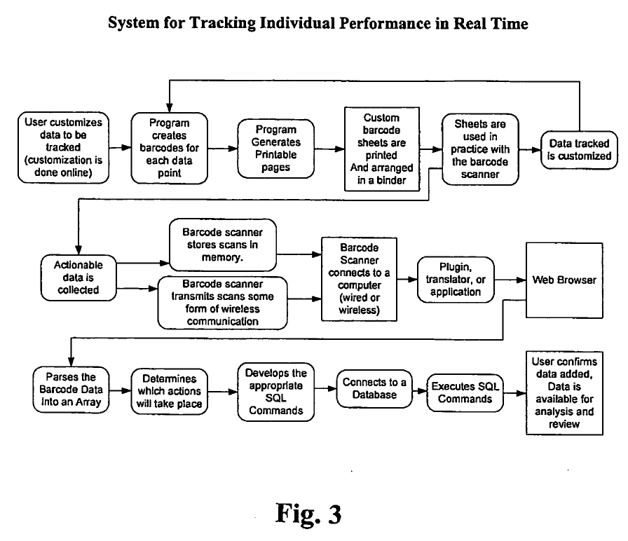

FIG. 3 illustrates tracking of performance. Initially, the user customizes data to be tracked, for example, data regarding health, behavior, etc. A barcode is then created for each datapoint and the program creates printable pages. Custom barcode sheets are printed and arranged in a binder. The barcode scanner is then used to scan a desired barcode in the list of barcodes on the barcode sheet. At any given point it is possible to customize the data being tracked and create new barcodes for new data points. After the desired barcode is scanned, actual data is collected and the barcode scanner either stores the scans in a memory or transmits the scans to a computer wirelessly. The bar code data is then parsed into an array, actions which will take place are then determined, and appropriate SQL commands are developed. Connection is then made to a database and the SQL commands are executed, after which the user confirms the data added.

The overall system for collecting objective and subjective performance data of students, has a barcode scanner, software for generating bar codes, equipment for entering audio, image and/or input video input, a central database for storing the input from the equipment, and control software for accessing files based upon scanned barcodes and entering and updating information in the database. The method is carried out by scanning the bar code of a desired data entry field, entering objective data (for example as audio, image and/or video input) relative to the desired data entry field into the central database, and accessing the entered data at a later date to prepare a subjective evaluation of student performance.

A list containing a plurality of barcodes can be provided wherein each barcode is associated with a separate data entry field. The data entry fields can, for example, be attendance, behavior, family notes, health notes, performance, reading or special abilities. Of course, any desired topic can make up a data field as determined by the needs of the teacher, administrator, school district, etc.

Furthermore, each student has a specific barcode associated to him/her. A selected student's bar code is scanned for entering data for the desired data entry field relative to the selected student.

The evaluation objects (i.e. video, audio, images) can be entered in a wide variety of ways, for example using a digital camera, a digital camcorder or video recorder, an image scanner or a voice recorder. For convenience of operation it is desirable to have the barcode scanner incorporated in the digital camera, the digital camcorder or video recorder, the image scanner or the voice recorder. The subjective evaluation conclusions or observations can also be categorized with barcodes so that it is possible to easily enter preset phrases or statements conveying the results of the subjective evaluation.

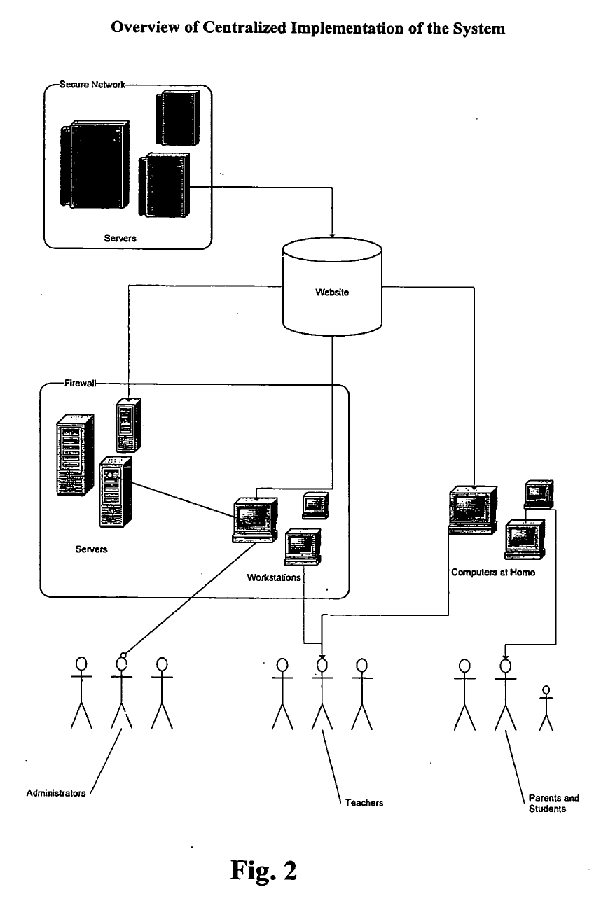

FIG. 2 schematically illustrates an overview of the inventive system and how the database could be accessed by authorized users. Methods of securing a database and limiting access to authorized individuals are known in the art and will not be address further here.

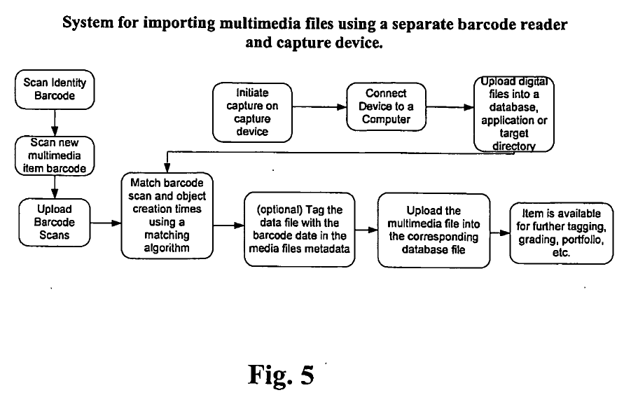

FIG. 5 is a flow chart showing how multimedia files of objective data can be imported into the database. First, a student identity barcode is scanned, followed by scanning of a new multimedia item barcode and the barcode scans are uploaded. A capture device captures audio and/or video and/or still image and creates a digital file. The capture device is connected to a computer and the digital file is uploaded into a database, application or target directory. Next, barcode and object creation times are matched using a matching algorithm. At this point the data file can be tagged with the barcode date in the media file's metadata, if desired. The multimedia file is then uploaded into the corresponding database file and the item is available for further tagging, grading, portfolio, etc.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A system for collecting objective and subjective performance data of students, comprising:
a barcode scanner;
software for generating bar codes;
equipment for entering audio, image and/or input video input;
a central database for storing the input from the equipment; and
control software for accessing files based upon scanned barcodes and entering and updating information in the database.

2. The system for collecting objective and subjective performance data of students as in claim 1, and further comprising a list containing a plurality of barcodes, each barcode being associated with a separate data entry field.

3. The system for collecting objective and subjective performance data of students as in claim 2, wherein the data entry fields include at least one of the group consisting of attendance, behavior, family notes, health notes, performance, reading and special abilities.

4. The system for collecting objective and subjective performance data of students as in claim 1, wherein each student has a specific barcode associated to him/her.

5. The system for collecting objective and subjective performance data of students as in claim 1, wherein the equipment includes a digital camera.

6. The system for collecting objective and subjective performance data of students as in claim 5, wherein the digital camera includes the barcode scanner.

7. The system for collecting objective and subjective performance data of students as in claim 1, wherein the equipment includes a digital camcorder.

8. The system for collecting objective and subjective performance data of students as in claim 7, wherein the barcode scanner is incorporated in the camcorder.

9. The system for collecting objective and subjective performance data of students as in claim 1, wherein the equipment includes an image scanner.

10. The system for collecting objective and subjective performance data of students as in claim 9, wherein the barcode scanner is incorporated in the image scanner.

11. The system for collecting objective and subjective performance data of students as in claim 1, wherein the equipment includes a voice recorder, the barcode scanner being incorporated in the voice recorder.

12. A method for collecting and tracking objective and subjective performance data of students, comprising the steps of:
selecting data entry fields to be tracked;
entering objective data to a desired data entry field into a central database; and
accessing the entered data at a later date for subjective evaluation to track student performance.

13. The method for collecting and tracking objective and subjective performance data of students according to claim 12, further including assigning a bar code to each data entry field and scanning the bar code of the desired data entry field prior to entering the objective data.

14. The method for collecting and tracking objective and subjective performance data of students according to claim 12, wherein the data entry fields include at least one of the group consisting of attendance, behavior, family notes, health notes, performance, reading and special abilities.

15. The method for collecting and tracking objective and subjective performance data of students according to claim 13, further including assigning a specific bar code to each student.

16. The method for collecting and tracking objective and subjective performance data of students according to claim 15, including scanning a selected student's bar code for entering data for the desired data entry field relative to the selected student.

17. The method for collecting and tracking objective and subjective performance data of students according to claim 12, wherein the step of entering data includes entering data with at least one of the group consisting of a digital camera, a digital video camera, an image scanner and a voice recorder.

18. The method for collecting and tracking objective and subjective performance data of students according to claim 17, wherein a barcode scanner is arranged in the digital camera, the digital video camera, the image scanner or the voice recorder.

19. The method for collecting and tracking objective and subjective performance data of students according to claim 13, wherein the accessing step includes accessing the database via the internet and scanning specific bar codes to access desired students and data fields.

20. The method for collecting and tracking objective and subjective performance data of students according to claim 12, further including storing results of the subjective evaluation.
